(19) United States
(12) Patent Application Publication
(10) Pub. No.: US 2011/0320544 A1
(43) Pub. Date: Dec. 29, 2011

(54) DIAMETER SESSION AUDITS

(75) Inventors: Matthew Yee, Ottawa (CA); Robert Alexander Mann, Carp (CA)

(73) Assignee: Alcatel-Lucent Canada, Inc., Ottawa (CA)

(21) Appl. No.: 12/825,654

(22) Filed: Jun. 29, 2010

(51) Int. Cl. G06F 15/16

(52) U.S. Cl. 709/206; 709/228

(57) ABSTRACT

Various exemplary embodiments relate to a method performed by a Policy and Charging Rules Node (PCRN) for managing communications sessions. The method may include: determining that a session is suspect of being inactive; sending an innocuous message to a network component that initiated the session; waiting for a response from the network component; if the PCRN receives a response from the network component, determining whether the session is inactive based on the response; and taking at least one management action for the session if the session is inactive. Various exemplary embodiments relate to a PCRN for managing communications sessions. The PCRN may include: one or more interfaces that communicate with network components, one or more PCRN blades that manage communications sessions, and a diameter proxy agent that determines which blade manages a session. Each PCRN blade may include a session manager, a timer and a session data storage.

### TECHNICAL FIELD

Various exemplary embodiments disclosed herein relate generally to policy and charging in telecommunications networks.

### BACKGROUND

As the demand increases for varying types of applications within mobile telecommunications networks, service providers must constantly upgrade their systems in order to reliably provide this expanded functionality. What was once a system designed simply for voice communication has grown into an all-purpose network access point, providing access to a myriad of applications including text messaging, multimedia streaming, and general Internet access. As seen in second and third generation networks, voice services must be carried over dedicated voice channels and directed toward a circuit-switched core, while other service communications are transmitted according to the Internet Protocol (IP) and directed toward a different, packet-switched core. This led to unique problems regarding application provision, metering and charging, and quality of experience (QoE) assurance.

In an effort to simplify the dual core approach of the second and third generations, the 3rd Generation Partnership Project (3GPP) has recommended a new network scheme it terms “Long Term Evolution” (LTE). In an LTE network, all communications are carried over an IP channel from user equipment (UE) to an all-IP core called the Evolved Packet Core (EPC). The EPC then provides gateway access to other networks while ensuring an acceptable QoE and charging a subscriber for their particular network activity.

The 3GPP generally describes the components of the EPC and their interactions with each other in a number of technical specifications. Specifically, 3GPP TS 29.212, 3GPP TS 29.213, and 3GPP TS 29.214 describe the Policy and Charging Rules Function (PCRF), Policy and Charging Enforcement Function (PCEF), and Bearer Binding and Event Reporting Function (BBERF) of the EPC. These specifications further provide some guidance as to how these elements interact in order to provide reliable data services and charge subscribers for use thereof.

For example, 3GPP TS 29.212, 29.213, and 29.214 specifications provide some guidance on establishing and terminating communication sessions such as, for example, Internet Protocol Communications Access Network (IP-CAN) sessions, Application Function (AF) sessions and Gateway (GW) sessions. 3GPP TS 29.213 describes the steps taken by a PCRF when it receives a session termination request. For example, if the PCRF receives an IP-CAN session termination request, the PCRF may instruct the BBERF, PCEF and AF to terminate sessions bound to the IP-CAN session.

Communications networks, however, are not guaranteed to be reliable. The 3GPP standards provide little guidance about how to handle communication failures within the EPC. For example, a termination request may not reach the PCRF, in which case the session and any bound sessions may not be terminated at every network component, creating an orphaned session. A session may also be inactive at the network component that initiated the session, but active at other network components. These orphaned and inactive sessions continue to consume system resources such as, for example, guaranteed bandwidth, system memory and processing time.

In view of the foregoing, it would be desirable to provide a Policy and Charging Rules Node (PCRN) implementing a PCRF capable of removing orphaned or inactive sessions. In particular, it would be desirable to detect and terminate orphaned and inactive sessions without interfering with the operation of other network components.

### SUMMARY

In light of the present need for a PCRN for removing orphaned sessions, a brief summary of various exemplary embodiments is presented. Some simplifications and omissions may be made in the following summary, which is intended to highlight and introduce some aspects of the various exemplary embodiments, but not to limit the scope of the invention. Detailed descriptions of a preferred exemplary embodiment adequate to allow those of ordinary skill in the art to make and use the inventive concepts will follow in later sections.

Various exemplary embodiments relate to a method performed by a Policy and Charging Rules Node (PCRN) for managing communications sessions. The method may include: determining that a session is suspect of being inactive; sending an innocuous message to a network component that initiated the session; waiting for a response from the network component; if the PCRN receives a response from the network component, determining whether the session is inactive based on the response; and taking at least one management action for the session if the session is inactive. Inactive sessions may include orphaned sessions or any other session that is no longer active at the network component that initiated the session. An innocuous message may be any message which does not substantially change the state of the session at the receiving network component. Network management actions may include logging the session, sending an SNMP trap and/or terminating the session. Various exemplary embodiments relate to the above method encoded on a machine-readable storage medium as instructions for a PCRN to manage communications sessions.

Various exemplary embodiments relate to a policy and charging rules node (PCRN) for managing communications sessions on a network. The PCRN may include: a session data storage that stores data regarding sessions comprising an activity timestamp that indicates the time of the last PCRN activity for the session; a timer that measures the current time and determines that a session is suspect of being inactive based on the activity timestamp and the current time; and a session manager that sends an innocuous message to a network component that initiated the suspect session and terminates the suspect session when a response indicates the session is inactive.

It should be apparent that, in this manner, various exemplary embodiments provide for conducting Diameter session audits at a PCRN. In particular, by using innocuous messages to detect inactive sessions, the PCRN may free network resources without interfering in the operation of other network components. Furthermore, by treating the discovery of an inactive session as if it were a termination request, the PCRN may efficiently correct communication errors.

### BRIEF DESCRIPTION OF THE DRAWINGS

In order to better understand various exemplary embodiments, reference is made to the accompanying drawings, wherein:

FIG. 1 illustrates an exemplary subscriber network for providing various data services;

FIG. 2 illustrates an exemplary PCRN for managing sessions;

FIG. 3 illustrates an exemplary PCRN blade for conducting session audits;

FIG. 4 illustrates an exemplary data arrangement for storing proxy data;

FIG. 5 illustrates an exemplary data arrangement for storing session data;

FIG. 6 illustrates an exemplary method for conducting a session audit;

FIG. 7 is an exemplary message diagram illustrating the exchange of messages between entities in the network of FIG. 1 during an IP-CAN session audit;

FIG. 8 is an exemplary message diagram illustrating the exchange of messages between entities in the network of FIG. 1 during an AF session audit; and

FIG. 9 is an exemplary message diagram illustrating the exchange of messages between entities in the network of FIG. 1 during a GW control session audit.

### DETAILED DESCRIPTION

Referring now to the drawings, in which like numerals refer to like components or steps, there are disclosed broad aspects of various exemplary embodiments.

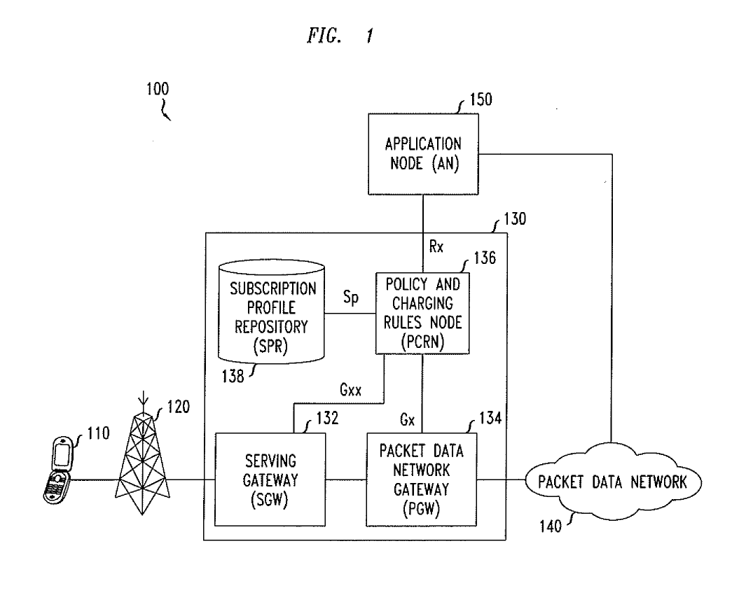

FIG. 1 illustrates an exemplary subscriber network 100 for providing various data services. Exemplary subscriber network 100 may be a telecommunications network or other network for providing access to various services. Exemplary subscriber network 100 may include user equipment 110, base station 120, evolved packet core (EPC) 130, packet data network 140, and application node (AN) 150.

User equipment 110 may be a device that communicates with packet data network 140 for providing the end-user with a data service. Such data service may include, for example, voice communication, text messaging, multimedia streaming, and Internet access. More specifically, in various exemplary embodiments, user equipment 110 is a personal or laptop computer, wireless email device, cell phone, smart phone, television set-top box, or any other device capable of communicating with other devices via EPC 130.

Base station 120 may be a device that enables communication between user equipment 110 and EPC 130. For example, base station 120 may be a base transceiver station such as an evolved nodeB (eNodeB) as defined by 3GPP standards. Thus, base station 120 may be a device that communicates with user equipment 110 via a first medium, such as radio waves, and communicates with EPC 130 via a second medium, such as Ethernet cable. Base station 120 may be in direct communication with EPC 130 or may communicate via a number of intermediate nodes (not shown). In various embodiments, multiple base stations (not shown) may be present to provide mobility to user equipment 110. Note that in various alternative embodiments, user equipment 110 may communicate directly with evolved packet core 130. In such embodiments, base station 120 may not be present.

Evolved packet core (EPC) 130 may be a device or network of devices that provides user equipment 110 with gateway access to packet data network 140. EPC 130 may further charge a subscriber for use of provided data services and ensure that particular quality of experience (QoE) standards are met. Thus, EPC 130 may be implemented, at least in part, according to the 3GPP TS 29.212, 29.213, and 29.214 standards. Accordingly, EPC 130 may include a serving gateway (SGW) 132, a packet data network gateway (PGW) 134, a policy and charging rules node (PCRN) 136 and a subscriber profile repository (SPR) 138.

Serving gateway (SGW) 132 may be a device that manages data paths between the base station 120 and PGW 134. The data paths may include virtual containers called bearers with unique Quality of Service (QoS) characteristics. The bearers may include virtual connections called service data flows (SDFs). In various embodiments where user equipment 110 is a mobile device and base station 120 is an eNodeB, SGW 132 may be responsible for establishing new bearers when the mobile device changes eNodeB. The SGW 132 may implement a bearer binding and event reporting function (BBERF) according to the 3GPP TS 29.212, 29.213, and 29.214 standards. In various embodiments, EPC 130 may include multiple serving gateways.

Packet data network gateway (PGW) 134 may be a device that provides gateway access to packet data network 140. PGW 134 may be the final device within the EPC 130 that receives packets sent by user equipment 110 toward packet data network 140 via SGW 132. PGW 134 may include a policy and charging enforcement function (PCEF) that enforces policy and charging control (PCC) rules for each service data flow (SDF). Thus, PGW 134 may be a policy and charging enforcement node (PCEN). PGW 134 may request new PCC rules from PCRN 136 by sending a CCR message via the Gx interface. PGW 134 may also include a number of additional features such as, for example, packet filtering, deep packet inspection, and subscriber charging support.

Policy and charging rules node (PCRN) 136 may be a device that establishes and manages Internet Protocol Connectivity Access Network (IP-CAN) sessions, AF sessions and GW control sessions. PCRN 136 may establish IP-CAN sessions to assign an IP address and enable network access for a UE such as UE 110. PCRN 136 may also create PCC rules for appropriate billing for the IP-CAN session. PCRN 136 may establish GW control sessions with an SGW such as, for example, SGW 132 to establish a communication path for transferring access specific parameters, BBERF events and QoS rules between the PCRN 136 and the SGW. PCRN 136 may establish AF sessions with an AN such as, for example, AN 150 to allow communication regarding a service for a subscriber.

PCRN 136 may also receive requests for application services, generate PCC rules, and provide PCC rules to the PGW 134 and/or other PCENs (not shown). PCRN 136 may be in communication with AN 150 via an Rx interface. PCRN 136 may also be in communication with SGW 132 and PGW 134 via a Gxx and a Gx interface, respectively. Upon creating a new PCC rule or upon request by the PGW 134, PCRN 136 may provide a PCC rule to PGW 134 via the Gx interface. In various embodiments, such as those implementing the Proxy Mobile IP (PMIP) standard for example, PCRN 136 may also generate QoS rules. Upon creating a new QoS rule or upon request by the SGW 132, PCRN 136 may provide a QoS rule to SGW 132 via the Gxx interface. During operation, PCRN 136 may record a timestamp for the last action associated with each session.

Subscription profile repository (SPR) 138 may be a device that stores information related to subscribers to the subscriber network 100. Thus, SPR 138 may include a machine-readable storage medium such as read-only memory (ROM), random-access memory (RAM), magnetic disk storage media, optical storage media, flash-memory devices, and/or similar storage media. SPR 138 may be a component of PCRN 136 or may constitute an independent node within EPC 130. Data stored by SPR 138 may include an identifier of each subscriber and indications of subscription information for each subscriber such as bandwidth limits, charging parameters, subscriber priority, and subscriber service preferences.

Packet data network 140 may be any network for providing data communications between user equipment 110 and other devices connected to packet data network 140, such as AN 150. Further, packet data network 140 may provide, for example, phone and/or Internet service to various user devices in communication with packet data network 140.

Application Node (AN) 150 may be a device that provides an application service to user equipment 110. Thus, AN 150 may be a server or other device that provides, for example, streaming video service to user equipment 110. AN 150 may implement an application function for providing the application service and communicating with PCRN 136. AN 150 may further be in communication with the PCRN 136 of the EPC 130 via an Rx interface. When AN 150 is to begin providing application service to user equipment 110, AN 150 may generate an application authorization request message, such as an AA•Request (AAR) according to the Diameter protocol, to notify the PCRN 136 that resources should be allocated for the application service. Such an application request message may include information such as an identification of the subscriber using the application service and an identification of the particular service data flows that must be established within an IP-CAN session in order to provide the requested service. AN 150 may communicate such an application request to the PCRN via the Rx interface 215.

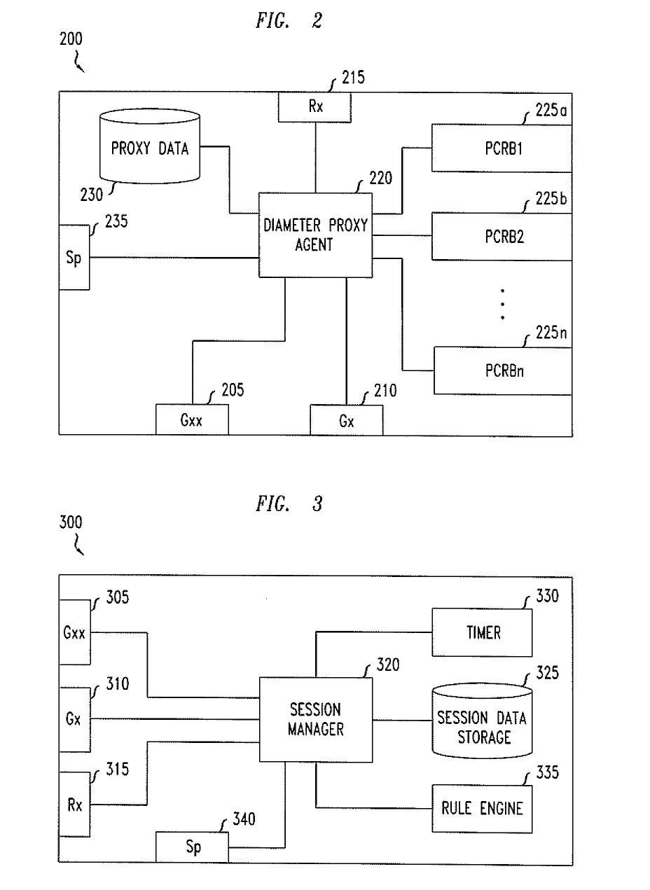

Having described the components of subscriber network 100, a brief summary of the operation of subscriber network 100 will be provided. It should be apparent that the following description is intended to provide an overview of the operation of subscriber network 100 and is therefore a simplification in some respects. The detailed operation of subscriber network 100 will be described in further detail below in connection with FIGS. 2-9.

PCRN 136 may perform session audits to determine whether any established session has become inactive, orphaned, or stale. PCRN 136 may perform session audits at regular intervals to detect sessions that are suspect of being inactive. PCRN 136 may determine that a session is suspect of being inactive if the elapsed time since the most recent activity timestamp exceeds a suspect inactivity time. When PCRN 136 determines that a session is suspect of being inactive, it may send an innocuous message to the network component that initiated the session. An innocuous message may be a request message that will not change the state of the session at the network component. For an IP-CAN session or a GW control session, an innocuous message may be an RAR command provisioning event triggers. For an AF session, an innocuous message may be an RAR command including a specific action.

Network components may respond to an innocuous message with an RAA command indicating a result code of either a DIAMETER_SUCCESS (2001) or DIAMETER_UNKNOWN_SESSION_ID (5002). The diameter success code may indicate that the session is active at the network component. In this case, PORN 136 may update the session activity timestamp without taking further action. The diameter unknown session ID code may indicate that the session is inactive, or has been terminated or orphaned, by the network component. In this case, PCRN 136 may take a management action for the session such as, for example, terminating the session, logging the session, and/or sending a simple network management protocol (SNMP) trap to inform a network management entity (NME) about the session.

FIG. 2 illustrates an exemplary PCRN 200 for managing sessions. PCRN 200 may correspond to PCRN 136 of exemplary subscriber network 100. PCRN 200 may include Gx interface 205, Gxx interface 210, Rx interface 215, diameter proxy agent (DPA) 220, PCRN blades 225a, 225b, . . . 225n, and proxy data storage 230.

Gxx interface 205 may be an interface comprising hardware and/or executable instructions encoded on a machine-readable storage medium configured to communicate with a serving gateway such as SGW 132. Such communication may be implemented according to the 3GPP TS 29.212 and 29.213. For example, Gxx interface 205 may receive GW control session establishment requests from SGW 132 and send QoS rules to SGW 132.

Gx interface 210 may be an interface comprising hardware and/or executable instructions encoded on a machine-readable storage medium configured to communicate with a packet data network gateway, such as PGW 134. Such communication may be implemented according to the 3GPP TS 29.212 and 29.213. For example, Gx interface 210 may receive IP-CAN session establishment requests and event messages from PGW 134 and send PCC rules to PGW 134.

Rx interface 215 may be an interface comprising hardware and/or executable instructions encoded on a machine-readable storage medium configured to communicate with a packet data network gateway, such as PGW 134. Such communication may be implemented according to the 3GPP TS 29.213 and 29.214. For example, Rx interface 215 may receive AF session requests from AN 150.

Diameter proxy agent (DPA) 220 may include hardware and/or executable instructions encoded on a machine-readable storage medium configured to manage sessions at the PCRN 200. DPA 220 may be responsible for binding related sessions together. DPA 220 may receive messages via Gxx interface 205, Gx interface 210 and/or Rx interface 215. If a session already exists for the message, DPA 220 may determine which PCRN blade 225 is responsible for the session. DPA 220 may then forward the message to the appropriate PCRN blade 225 for processing. If the message is a session establishment request, DPA 220 may decide which PCRN blade 225 to assign to managing the session. DPA 220 may decide to bind the new session to one or more existing session and forward the message to the PCRN blade 225 responsible for the bound session. DPA 220 may use proxy data storage 230 to store information for use in selecting PCRN blades. During a session audit DPA 220 may use information in the audit messages to update proxy data storage 230 to include correct session and binding information.

PCRN blades 225a, 225b, . . . 225n may include hardware and/or executable instructions encoded on a machine-readable storage medium configured to manage communications sessions at the PCRN 200. Each PCRN blade 225 may implement a Policy and Charging Rules Function (PCRF). In various alternative embodiments that do not use a DPA, a single PCRN blade 225 may function as PCRN 200. As will be described in further detail with regard to FIGS. 3-9, each PCRN blade 225 may conduct session audits to determine if any of the sessions it is managing have become orphaned or inactive.

Proxy data storage 230 may be any machine-readable medium capable of storing proxy data. Proxy data may be used by DPA 220 to determine to which PCRN blade 225 a session is assigned. Proxy data may also be used to determine whether sessions should be bound together. As will be described in further detail with regard to FIG. 4, proxy data may include a session ID, subscription ID, PCRN blade ID, a list of bound session IDs, and other information useful for managing sessions.

Sp interface 235 may be an interface including hardware and/or executable instructions encoded on a machine-readable storage medium configured to communicate with an SPR such as SPR 138. Sp interface 235 may transmit record requests and receive subscription profile records. DPA 220 may request subscription profile records from Sp interface 235 for use in determining which sessions should be bound together.

FIG. 3 illustrates an exemplary PCRN blade 300 for managing communications sessions. PCRN blade 300 may correspond to PCRN blades 225. In various alternative embodiments, PCRN blade 300 may correspond to PCRN 136. PCRN blade 300 may include Gxx interface 305, Gx interface 310, Rx interface 315, session manager 320, session data storage 325, timer 330, and Sp interface 335.

Gxx interface 305 may be similar to Gxx interface 205. Gx interface 310 may be similar to Gx interface 210. Rx interface 315 may be similar to Rx interface 215. Sp interface 335 may be similar to Sp interface 235. Gxx interface 305, Gx interface 310, Rx interface 315, and Sp interface 340 may communicate indirectly with their respective network components through DPA 220. In various alternative embodiments, Gxx interface 305, Gx interface 310, Rx interface 315, and Sp interface 340 may communicate directly with their respective network components.

Session manager 320 may include hardware and/or executable instructions encoded on a machine-readable storage medium configured to establish and manage communications sessions. Session manager 320 may receive IP-CAN session establishment requests from SGW 132 through PGW 134 and Gx interface 310. GW control session requests from SGW 132 may arrive at session manager 320 via Gxx interface 305. Session manager 320 may receive AF session requests from ANs such as AN 150. When establishing sessions, session manager 320 may store session data regarding active sessions in session data storage 325. Session manager 320 may also monitor active sessions and terminate sessions based on internal or external triggers. Session manager 320 may manage sessions by updating information in session data storage 325 and communicating changes in the session to the appropriate network elements via Gxx interface 305, Gx interface 310, and Rx interface 315.

When timer 330 determines that a session is suspect of being inactive or orphaned, session manager 320 may conduct session audits. Session manager 320 may generate innocuous messages based on session data stored in session data storage 325. Session manager 320 may take session management actions based on the response to the innocuous message. For example, session manager 320 may terminate the session if the response indicates that the session is inactive. If session manager 320 does not receive a response, session manager 320 may take a session management action based on a default assumption such as, for example, lack of response indicates that the session is inactive.

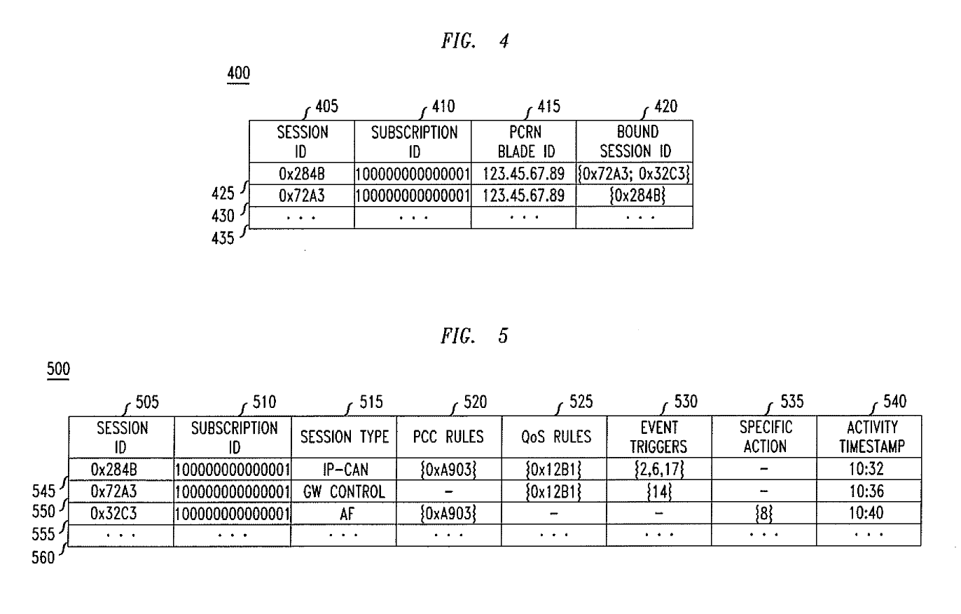

Session data storage 325 may be any machine-readable medium capable of storing session data. As will be described in further detail with regard to FIG. 5, session data may include, for example, a session ID, subscription ID, session type, PCC rules, QoS rules, activity timestamp, event triggers and/or specific actions for each session.

Timer 330 may include hardware and/or executable instructions encoded on a machine-readable storage medium configured to determine when a session is suspect of being inactive. Timer 330 may monitor the current time. Timer 330 may be configured with an audit interval and a suspect inactivity time. The audit interval may be configured by an operator or calculated based on factors such as, for example, forwarding class, bearer type, total bandwidth allocated, and/or application type. Generally, as more resources are used by a session, a shorter audit interval becomes more desirable. Each time the audit interval passes, timer 330 may compare the activity timestamp for each session with the current time. If the difference between the activity timestamp and the current time exceeds the suspect inactivity time, timer 330 may request session manager 320 to perform a session audit.

Rule engine 335 may include hardware and/or executable instructions encoded on a machine-readable storage medium configured to generate and/or modify PCC and/or QoS rules. Rule engine 335 may generate PCC/QoS rules when session manager 320 first establishes a communications session. Rule engine 335 may generate new rules or delete existing rules when session manager 320 takes session management actions. For example, rule engine 335 may delete existing PCC rules for an IP-CAN session to eliminate an AF session that has been terminated. Rule engine 335 may update session data storage 325 whenever it generates or deletes a PCC/QoS rule.

FIG. 4 illustrates an exemplary data arrangement 400 for storing proxy data. Data arrangement 400 may be, for example, a table in a database stored in proxy data storage 230. Alternatively, data arrangement 400 could be a series of linked lists, an array, or a similar data structure. Thus, it should be apparent that data arrangement 400 is an abstraction of the underlying data; any data structure suitable for storage of this data may be used.

Data arrangement 400 may include data fields such as, for example, session ID field 405, subscription ID field 410, PCRN Blade ID 415, and bound session IDs field 420. Data arrangement 400 may include additional fields (not shown) required or useful in defining sessions and binding status. Data arrangement 400 may include multiple entries for sessions such as, for example, entries 425, 430 and 435.

Session ID field 405 may include a name assigned to an individual IP-CAN session. Values stored by session ID field 405 may be assigned by DPA 220 during session establishment. Session ID field 405 may be used as the Session-ID AVP in Diameter messages regarding a particular communication session. Subscription ID field 310 may include one or more names, numbers, and/or strings used to identify a subscription or subscriber record associated with communication session. Subscription ID 410 field may include, for example, International Mobile Subscriber Identification numbers (IMSI), Mobile Station International Subscriber Directory Numbers (MSISDN), Session Initiation Protocol Uniform Resource Indicators (SIP URI), and/or Network Access Identifiers (NAI). Subscription ID 410 may be used to locate a record corresponding to a request for subscriber records from SPR 138. PCRN Blade ID field 415 may indicate the PCRN blade 225 to which the session is assigned using, for example, an IP address, MAC address or other method that allows DPA 220 to address traffic to a PCRN blade. Bound session IDs field 420 may indicate any other sessions to which the session has been bound.

As an example of an entry in data arrangement 400, entry 425 may indicate a session “0x284B” for a subscriber “100000000000001.” The session has been assigned to PCRN blade 123.45.67.89. The session is bound to sessions “0x72A3” and “0x32C3.” As a second example of an entry in data arrangement 400, entry 430 may indicate a session “0x72A3” for a subscriber “100000000000001.” The session has also been assigned to PCRN blade 123.45.67.89. The session is bound to session “0x284B.” Entry 435 may indicate that data arrangement 400 may include additional entries for additional sessions.

FIG. 5 illustrates an exemplary data arrangement 500 for storing session data. Data arrangement 500 may be, for example, a table in a database stored in session data storage 325. Alternatively, data arrangement 500 could be a series of linked lists, an array, or a similar data structure. Thus, it should be apparent that data arrangement 500 is an abstraction of the underlying data; any data structure suitable for storage of this data may be used.

Data arrangement 500 may include data fields such as, for example, session ID field 505, subscription ID field 510, session type field 515, PCC rules field 520, QoS rules field 525, event triggers field 530, specific action field 535, and activity timestamp 540. Data arrangement 500 may include additional fields (not shown) required or useful in defining communications sessions. Data arrangement 500 may include multiple entries for sessions such as, for example, sessions 545, 550, 555, and 560.

Session ID field 505 may correspond to session ID field 405. Session ID field 505 may be used identify the session when managing records and communicating with network components. Subscription ID field 510 may be similar to subscription ID field 410. Subscription ID field 510 may be used to identify a subscriber associated with the session. Session type field 515 may include an indication of the type of communication session. Session types may include IP-CAN, GW control, AF, and any other type of session managed by PCRN 136. PCC rules field 520 may include a list of PCC rule names that are active for the session. QoS rules field 525 may include a list of QoS rule names that are active for the session. Event triggers field 530 may include a list of event triggers that are provisioned for the session. Event triggers field 530 may include no value for AF sessions. Specific action field 535 may include a list of specific actions that are provisioned for the session. IP-CAN sessions and GW control session may include no specific actions. Activity timestamp field 540 may include an indication of the time of the last action that PCRN 136 took for the session. Activity timestamp field 540 may use, for example, a network time protocol (NTP) or UNIX time to indicate the time of the last action. For the sake of simplification, timestamp field 540 may be shown using the familiar short time pattern format (HH:mm) in the drawings and examples.

As an example of an entry in data arrangement 500, session 545 may indicate a session with a session ID of “0x284B” for a subscription ID of “100000000000001.” Session 545 is an IP-CAN session with one active PCC rule “0xA903” and one active QoS rule “0x12B1.” Session 545 lists event triggers 2, 6, and 17 as provisioned to the PGW for the IP-CAN session. The last activity for session 545 occurred at “10:32.”

As another example of an entry in data arrangement 500, session 550 may indicate a session with a session ID of “0x72A3” for a subscription ID of “100000000000001.” Session 550 is a GW control session with no active PCC rules and one active QoS rule “0x12B1.” Session 550 lists event trigger “14” as provisioned to the SGW for the GW control session, which may indicate that no event triggers are provisioned. The last activity for session 550 occurred at “10:36.”

As another example of an entry in data arrangement 500, session 5550 may indicate a session with a session ID of “0x32C3” for a subscription ID of “100000000000001.” Session 555 is an AF session with one active PCC rule “0xA903” and no active QoS rules. Session 545 lists specific action “8” as provisioned to the PGW for the AF session. The last activity for session 545 occurred at “10:40.” Session 560 may indicate that data arrangement 500 may include additional entries for additional sessions.

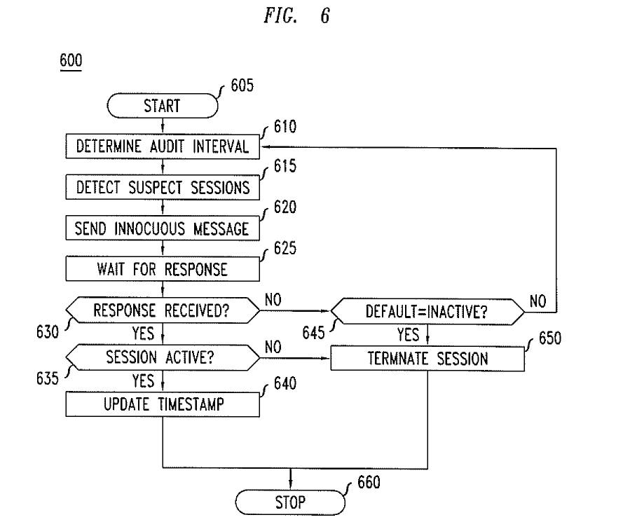

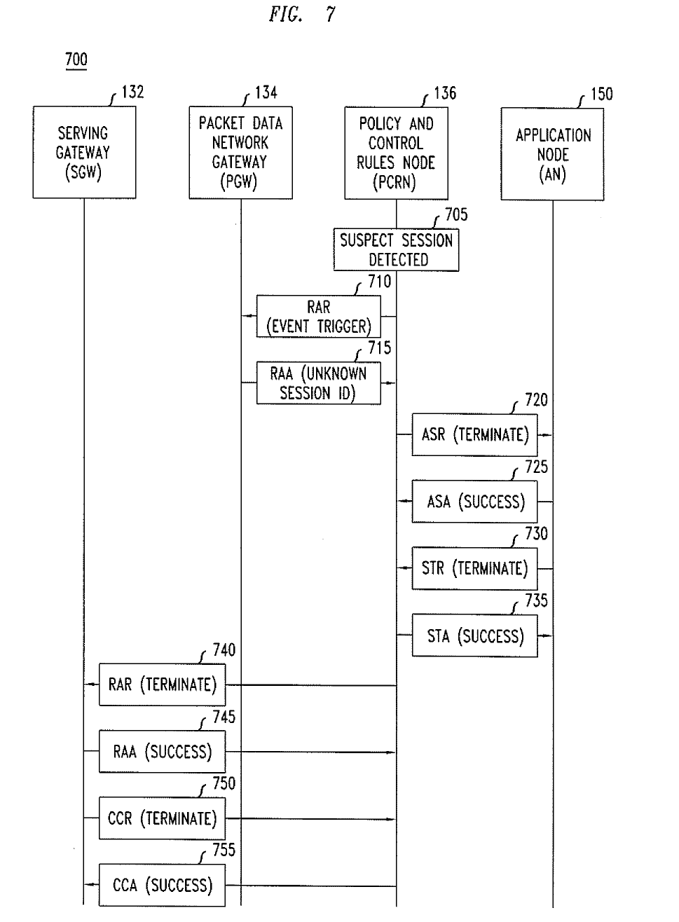

FIG. 6 illustrates an exemplary method 600 for conducting a session audit. Method 600 may begin at step 605 and proceed to step 610. In step 610, timer 330 may wait for a session audit interval to occur. In various exemplary embodiments, an audit interval may be configured for each session or for groups of sessions. Alternatively, timer 330 may be configured with a single audit interval that determines when all sessions are audited. Timer 330 may determine that the audit interval has occurred when the current time is equal to the previous audit time plus the audit interval. The method 600 may then proceed to step 615.

In step 615, timer 330 may detect suspect sessions. For each session in session data storage 325, timer 330 may compare the difference between the current time and the activity timestamp 540 with a suspect inactivity time. A session may be suspect if the difference exceeds the suspect inactivity time. Timer 330 may request session manager 320 to conduct a session audit for any suspect session. The method 600 may then proceed to step 620.

In step 620, session manager 320 may send an innocuous message to the network component that initiated the session. For an IP-CAN session, the network component may be a PGW. For a GW control session, the network component may be a SGW. For an AF session, the network component may be an AN. An innocuous message may be a request message that will not change the state of the session at the network component. As an example, an innocuous message for an IP-CAN session or a GW control session may be a RAR command provisioning event triggers. The provisioned event triggers may match event triggers stored in event triggers field 530, so that the request does not effect any session changes at the SGW or PGW. As another example, an innocuous message for an AF session may be an RAR command including a specific action. Session manager 320 may also include a proprietary AVP in the message to inform the DPA 220 of a default rule for treating a lack of response to the innocuous message.

In step 625, PCRN 136 may wait for a response from the network component. The PCRN 136 may wait for a sufficient time for the network component to respond. The waiting period may be configured, for example, based on an average response time for the network component. In step 630, session manager 320 and/or DPA 220 may determine whether a response to the innocuous message has been received. If a response is received, the method may proceed to step 635. If no response is received, the method may proceed to step 645.

In step 635, session manager 320 may determine whether the session is active based on the response. For example, if the response includes a DIAMETER_SUCCESS (2001), the response may indicate that the session is active at the network component. In this case, the method may proceed to step 640. As a further example, if the response includes a DIAMETER_UNKNOWN_SESSION_ID (5002), the response may indicate that the session is inactive, or has been terminated or orphaned, by the network component. In this case, the method may proceed to step 650.

In step 640, the session manager may update activity timestamp field 540 to include the time of the response. The method may then proceed to step 660, where the method ends.

Returning to step 630, the method may proceed to step 645 if the PCRN 136 does not receive a response. In step 645, the session manager may determine an action based on a default assumption. If the default assumption is that a lack of response indicates inactivity, the method may proceed to step 650. If the default assumption is that lack of response is not treated as inactivity, the method may return to step 610 to wait for another audit interval. In various embodiments, the default assumption may be that a lack of response is not treated as inactivity during the first n-1 audits, but is treated as inactivity the nth time. The value of n may be hard coded, defined by a configurable system variable, or defined for each session in session data storage 325. Session manager 320 may refrain from updating the session timestamp to determine how many audit intervals have occurred.

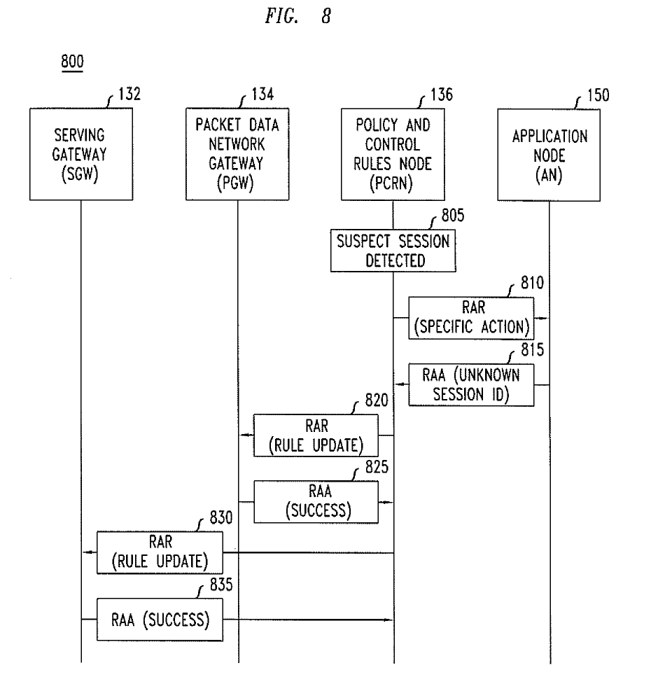

In step 650, the session manager 320 may take a management action for the inactive session. In various exemplary embodiments, the management action may be to terminate the session. The session manager 320 may treat the unknown session message as if it were a session termination message from the network component. As will be described in further detail with regard to FIGS. 7-9, session manager 320 may then send the appropriate messages to terminate the session at all network nodes. In various alternative embodiments, session manager 320 may manage the session by logging session information and/or sending a simple network management protocol (SNMP) trap message. The method may then proceed to step 660, where the method ends.

FIG. 7 is an exemplary message diagram 700 illustrating the exchange of messages between entities in the network of FIG. 1 during an IP-CAN session audit. In step 705, PCRN 136 may determine that an IP-CAN session is suspect of being inactive. Message 710 may be an innocuous message from PCRN 136 to PGW 134 in the form of an RAR command including an event trigger. Message 715 may be a response to message 710. PGW 134 may respond with an RAA command including a result code of either: DIAMETER_UNKNOWN_SESSION_ID (5002) or DIAMETER_SUCCESS (2001). If the result code is: DIAMETER_SUCCESS (2001), PCRN 136 may stop the session audit because the session is still active. If the result code is DIAMETER_UNKNOWN_SESSION_ID (5002), PCRN 136 may take a management action such as, for example, terminating the IP-CAN session and all related sessions.

Messages 720, 725, 730 and 735 may terminate an AF session associated with the IP-CAN session. Message 720 may be an Abort Session Request (ASR) command from PCRN 136 to AN 150 requesting termination of an AF session associated with the IP-CAN session. Upon receipt of message 720, AN 150 may stop sending data for the session and may update internal records to end the session. Message 725 may be an Abort Session Answer (ASA) command from AN 150 to PCRN 136 acknowledging the request of message 720. PCRN 136 may resend message 720 if it does not receive message 725. Message 730 may be a Session Termination Request (STR) command with a termination request from AN 150 to PCRN 136. Upon receipt of message 730, PCRN 136 may uninstall or delete PCC rules for the session. PCRN 136 may also delete session information related to the session from proxy data storage 230 and session data storage 325. Message 735 may be a Session Termination Answer (STA) command from PCRN 136 to AN 150 acknowledging the request of step 730. AN 150 may resend message 730 if it does not receive message 735. These messages may be sufficient to terminate an AF session at both PCRN 136 and AN 150. An IP-CAN session may be associated with multiple AF sessions, so messages 720, 725, 730, and 735 may be repeated for each AF session associated with the IP-CAN session.

Messages 740, 745, 750, and 755 may terminate a GW control session associated with the IP-CAN session. Message 740 may be a Re-Auth-Request (RAR) command from PCRN 136 to SGW 132 requesting termination of the GW control session. Upon receipt of message 740, SGW 150 may stop sending data for the session and may update internal records to end the session. Message 745 may be a Re-Auth-Answer (RAA) command from SGW 132 to PCRN 136 acknowledging the request of message 740. PCRN 136 may resend message 740 if it does not receive message 745. Message 750, may be a Credit Control Request (CCR) command from SGW 132 to PCRN 136 requesting PCRN 136 to terminate the GW control session. Upon receipt of message 750, PCRN 136 may uninstall or delete PCC rules for the session. PCRN 136 may also delete session information related to the session from proxy data storage 230 and session data storage 325. Message 755 may be a Credit Control Answer (CCA) command from PCRN 136 to SGW 132 acknowledging the request of message 750. SGW 132 may resend message 750 if it does not receive message 755. These steps may be sufficient to terminate a GW control session at both SGW 132 and PCRN 136. In various embodiments, messages 740, 745, 750 and 755 may not be used to terminate a GW control session. PCRN 136 may refrain from sending message 740 to start the termination.

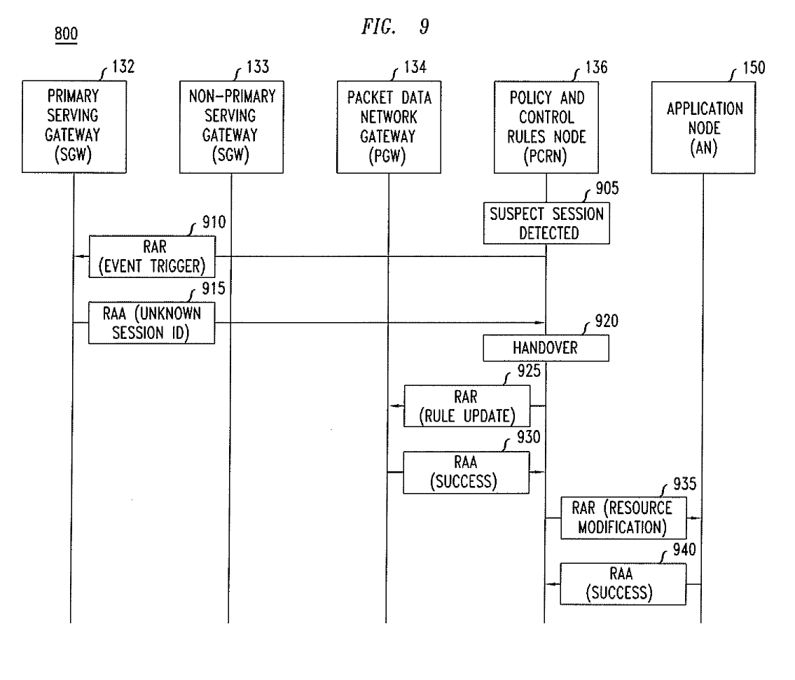

FIG. 8 is an exemplary message diagram 800 illustrating the exchange of messages between entities in the network of FIG. 1 during an AF session audit. In step 805, PCRN 136 may determine that an AF session is suspect of being inactive. Message 810, may be an innocuous message from PCRN 136 to AN 150 in the form of an RAR command including a specific action. Message 815, may be an RAA command from AN 150 to PCRN 136 including a result code of either DIAMETER_UNKNOWN_SESSION_ID (5002) or DIAMETER_SUCCESS (2001). If the result code is DIAMETER_SUCCESS (2001), PCRN 136 may stop the session audit because the session is still active. If the result code is DIAMETER_UNKNOWN_SESSION_ID (5002), PCRN 136 may take a management action such as, for example, terminating the AF session.

Messages 820 and 825 may update PCC rules associated with the AF session. Message 820 may be a RAR command from PCRN 136 to PGW 134 with a request to update the PCC rules. The update may include, for example, adding or removing PCC rules. Rule engine 335 may generate or modify PCC rules for inclusion within message 820. Message 825 may be an RAA command from PGW 134 to PCRN 136 indicating that the PCC rules have been updated. PCRN 136 may resend message 820 if it does not receive message 825.

Messages 830 and 835 may update QoS rules associated with the AF session. Message 830, may be a RAR command from PCRN 136 to SGW 132 with a request to update the QoS rules. The update may include, for example, adding or removing QoS rules. Rule engine 335 may generate or modify QoS rules for inclusion within message 830. Message 835 may be an RAA command from SGW 132 to PCRN 136 indicating that the QoS rules have been updated. PCRN 136 may resend message 830 if it does not receive message 835.

FIG. 9 is an exemplary message diagram 900 illustrating the exchange of messages between entities in the network of FIG. 1 during a GW control session audit. Primary serving gateway (P-SGW) 132 maybe the SGW currently serving data to UE 110. Non-primary serving gateway (NP-SGW) 133 may be an alternate SGW capable of serving UE 110 with a GW control session. In step 905, PCRN 136 may determine that a GW control session is suspect of being inactive. Message 910, may be an innocuous message in the form of an RAR command from PCRN 136 to P-SGW 132 including an event trigger. Message 915 may be an RAA command from P-SGW 132 to PCRN 136 responding to message 910 with a result code of either DIAMETER_UNKNOWN_SESSION_ID (5002) or DIAMETER_SUCCESS (2001). If the result code is DIAMETER_SUCCESS (2001), PCRN 136 may stop the session audit because the session is still active. If the result code is DIAMETER_UNKNOWN_SESSION_ID (5002), PCRN 136 may take a management action such as, for example, terminating the GW control session and performing a handover.

In step 920, PCRN 136 may determine whether there is any non-primary SGW with a GW control session associated with the same IP-CAN session as the inactive GW control session. For example, NP-SGW 133 may be a non-primary SGW with a GW control session linked to the same IP-CAN session as P-SGW 132. PCRN 136 may handover the IP-CAN session, appointing NP-SGW 133 as the new P-SGW. If there is no other SOW, PCRN 136 may terminate sessions associated with the GW control session.

Messages 925 and 930 may update the IP-CAN session associated with the GW control session with information concerning the new P-SOW. Message 925 may be an RAR command from PCRN 136 to PGW 134 requesting an update to the PCC rule(s) for the IP-CAN session. For example, rule engine 325 may have modified the PCC rule to make NP-SGW 133 the new P-SGW. Message 930, may be a RAA command from PGW 134 to PCRN 136 acknowledging the request of message 925. PCRN 136 may resend message 925 if it does not receive message 930.

Messages 935 and 940 may update any AF sessions associated with the GW control session with information concerning the new P-SGW. Message 935, may be an RAR command from PCRN 136 to AN 150 indicating a resource modification. For example, message 935 may include a specific action AVP to report an IP-CAN type change. Message 940 may be an RAA message from AN 150 to PCRN 136 acknowledging the request of message 935. PCRN 136 may resend message 935 if it does not receive message 940.

Having described exemplary components and methods for the operation of exemplary subscriber network 100 and PCRN 200, an example of the operation of exemplary network 100 and PCRN 200 will now be provided with reference to FIGS. 1-9. PCRN 136 may correspond to PCRN 200. The contents of session data storage 225 may be represented by data arrangement 300. The contents of proxy data storage 230 may be represented by data arrangement 400. The contents of session data storage 325 may be represented by data arrangement 500.

Before the process begins, the system may be configured with an audit interval such as, for example, 5 minutes, and a suspect inactivity time such as, for example, 10 minutes. The process may begin by determining whether an audit interval has arrived. For example, an audit interval may occur at 10:45 if the last audit was at 10:40. Timer 330 may then compare each time in activity timestamp field 540 to the current time minus the suspect inactivity time to determine which sessions are suspect of being inactive. Of the sessions in data arrangement 500, session 545 may be suspect of inactivity because the timestamp of 10:32 is more than 10 minutes before the current time of 10:45.

Session manager 320 may then conduct a session audit of session 545. Session manager 320 may construct an innocuous message by placing the session ID of “0x284B” and the event triggers of 2, 6, and 17 into an RAR message. Session manager 320 may then determine which PGW initiated the IP-CAN session from the PCC rules or a separate field (not shown) used to identify the PGW. Session manager 320 may then transmit the message to the PGW, which may be PGW 134.

If PGW 134 responds to the message with a success message including a result code of DIAMETER_SUCCESS (2001), session manager 320 may update the activity timestamp field 540 and end the audit because the session is active at PGW 134. It should be noted that the innocuous message didn't change the state of the session at either PGW 134 or PCRN 136.

If PGW 134 responds to the message with an unknown session ID message including a result code of DIAMETER_UNKNOWN_SESSION_ID (5002), session manager 320 may take a network management action. In various embodiments, session manager 310 may terminate the session by treating the unknown session ID message as a session termination request message. Session manager 320 may determine which sessions are associated with the IP-CAN session from the PCC rules field 520, QoS rules field 535 and/or bound session IDs field 420. Session 545 may be associated with sessions 550 because they share common PCC rule. Session 545 may be associated with session 555 because they share a common QoS rule. Data arrangement 400 also indicates that session ID “0x284B” is bound to sessions IDs “0x72A3” and “0x32C3.” As shown in FIG. 9, session manager 320 may use messages 720, 725, 730 and 735 to terminate each AF session associated with the IP-CAN session such as, for example, session 555 with session ID “0x32C3.” Session manager 320 may determine which AN to send the messages to based on the PCC rule and/or a separate AN address field (not shown). As further shown in FIG. 9, session manager 320 may use messages 740, 745, 750 and 755 to terminate any GW control session associated with the IP-CAN session such as, for example, session 550 with session ID “0x72A3.” Session manager 320 may determine which SGW to send the messages to based on the QoS rule and/or a separate SGW address field (not shown).

DPA 220 may also delete and/or modify records in data arrangement 400 based on the unknown session ID message. For example, DPA 220 may delete record 425 because the unknown session ID message indicates that the session is inactive at the PGW that initiated the session. DPA 220 may delete other records based on the termination messages described above.

If PGW 134 does not respond to the innocuous message within a waiting period, session manager 320 may rely on a default assumption to determine the status of the session. In various embodiments, session manager 320 may compare the time of the innocuous message to the session timestamp to determine how many audit intervals have passed. For example, if the audit occurs at 10:45 and the audit interval is 5 minutes, session manager 320 may determine that two audit intervals have passed for session 545. If the default assumption allows only one lack of response, session manager 320 may treat the lack of response as an unknown session ID message as described above.

According to the foregoing, various exemplary embodiments provide for conducting Diameter session audits at a PCRN. In particular, by using innocuous messages to detect inactive sessions, the PCRN may free network resources without interfering in the operation of other network components. Furthermore, by treating the discovery of an inactive session as if it were a termination request, the PCRN may efficiently correct communication errors.

It should be apparent from the foregoing description that various exemplary embodiments of the invention may be implemented in hardware and/or firmware. Furthermore, various exemplary embodiments may be implemented as instructions stored on a machine-readable storage medium, which may be read and executed by at least one processor to perform the operations described in detail herein. A machine-readable storage medium may include any mechanism for storing information in a form readable by a machine, such as a personal or laptop computer, a server, or other computing device. Thus, a machine-readable storage medium may include read-only memory (ROM), random-access memory (RAM), magnetic disk storage media, optical storage media, flash-memory devices, and similar storage media.

It should be appreciated by those skilled in the art that any block diagrams herein represent conceptual views of illustrative circuitry embodying the principals of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only and do not in any way limit the invention, which is defined only by the claims.

What is claimed is:

1. A method performed by a Policy and Charging Rules Node (PCRN) for managing communications sessions, the method comprising:
determining that a session is suspect of being inactive;
sending an innocuous message to a network component that initiated the session;
waiting for a response from the network component;
if the PCRN receives a response from the network component, determining whether the session is inactive based on the response; and
taking at least one management action for the session if the session is inactive.

2. The method of claim 1, wherein the step of determining that a session is suspect of being inactive comprises:
storing for each session an activity timestamp of the last action within the session;
determining an elapsed time since the activity timestamp for the session; and
determining that a session is suspect of being inactive if the elapsed time since the activity timestamp exceeds a suspect inactivity time.

3. The method of claim 1, wherein a gateway initiated the session and the step of sending an innocuous message comprises:
determining a set of event triggers that are currently provisioned for the session; and
sending a message to the gateway provisioning the same set of event triggers that are currently provisioned for the session.

4. The method of claim 1, wherein an application node initiated the session and the step of sending an innocuous message comprises:
determining a set of specific actions that are currently provisioned for the session; and
sending a message to the application node provisioning the same set of specific actions that are currently provisioned for the session.

5. The method of claim 1, wherein the response from the network component comprises one of: a success message and an unknown session message, the step of determining whether the session is inactive comprising:
determining that the session is inactive if the response comprises an unknown session message.

6. The method of claim 1, wherein the management action comprises at least one of:
terminating the session;
sending a simple network management protocol (SNMP) trap; and
logging the inactive session.

7. The method of claim 1, wherein the management action comprises:
treating the response as a session termination request from the network component that initiated the session.

8. The method of claim 1 further comprising:
setting a default assumption for a lack of response; and
if the PCRN does not receive a response from the network component within a waiting period, determining whether the session is inactive based on the default assumption.

9. The method of claim 8 wherein the innocuous message comprises an attribute value pair (AVP) indicating the default assumption for a lack of response.

10. A policy and charging rules node (PCRN) for managing communications sessions on a network, the PCRN comprising:
a session data storage that stores data regarding sessions comprising an activity timestamp that indicates the time of the last PCRN activity for the session;
a timer that measures the current time and determines that a session is suspect of being inactive based on the activity timestamp and the current time;
an first interface that transmits messages to a network component and receives messages from the network component; and
a session manager that sends an innocuous message to the network component that initiated the suspect session via the first interface and terminates the suspect session when a response message indicates the session is inactive.

11. The PCRN of claim 10 further comprising:
a plurality of PCRN blades, each PCRN blade comprising: a session data storage, a timer and a session manager;
a diameter proxy agent that determines which PCRN blade is responsible for managing a session; and
a proxy data storage that stores proxy data indicating bound sessions,
wherein the diameter proxy agent removes the terminated session and a bound session from the proxy data storage when a session manager terminates a session.

12. The PCRN of claim 11 further comprising:
a second interface that transmits a session termination message to a second network component responsible for the bound session when the diameter proxy agent removes the bound session.

13. The PCRN of claim 10 wherein the first interface is a Gx interface, wherein the session data storage comprises at least one event trigger provisioned for the network component that initiated the session, and the innocuous message comprises the at least one event trigger.

14. The PCRN of claim 10 wherein the first interface is an Rx interface, wherein the session data storage comprises at least one specific action provisioned for the network component that initiated the session, and the innocuous message comprises the at least one specific action.

15. A machine-readable storage medium encoded with instructions for a policy and rules charging node (PCRN) to manage communications sessions, the machine-readable storage medium comprising:
instructions for determining that a session is suspect of being inactive;
instructions sending an innocuous message to a network component that initiated the session;
instructions for waiting for a response from the network component;
instructions for determining whether the session is inactive based on the response if the PCRN receives a response from the network component; and
instructions for taking at least one management action for the session if the session is inactive.

16. The machine-readable storage medium of claim 15, wherein the instructions for determining that a session is suspect of being inactive comprise:
instructions for storing for each session an activity timestamp of the last action within the session;
instructions for determining an elapsed time since the activity timestamp for the session; and
instructions for determining that a session is suspect of being inactive if the elapsed time since the activity timestamp exceeds a suspect inactivity time.

17. The machine-readable storage medium of claim 15, wherein a gateway initiated the session and the instructions for sending an innocuous message comprise:
instructions for determining a set of event triggers that are currently provisioned for the session; and
instructions for sending a message to the gateway provisioning the same set of event triggers that are currently provisioned for the session.

18. The machine-readable storage medium of claim 15, wherein an application node initiated the session and the instructions for sending an innocuous message comprise:
instructions for determining a set of specific actions that are currently provisioned for the session; and
instructions for sending a message to the application node provisioning the same set of specific actions that are currently provisioned for the session.

19. The machine-readable storage medium of claim 15, wherein the response from the network component comprises one of: a success message and an unknown session message, the instructions for determining whether the session is inactive comprising:
instructions for determining that the session is inactive if the response comprises an unknown session message.

20. The machine-readable storage medium of claim 12, wherein the instructions for taking at least one management action comprise at least one of:
instructions for terminating the session;
instructions for sending a simple network management protocol (SNMP) trap;
instructions for logging the inactive session; and
instructions for treating the response as a session termination request from the network component that initiated the session.
